(19) United States
(12) Patent Application Publication
(10) Pub. No.: US 2007/0014950 A1
(43) Pub. Date: Jan. 18, 2007

(54) Capillary for analytical chemistry transparent to ultraviolet light

(76) Inventor: Griffin E. Stephen, Glendale, AZ (US)

Correspondence Address: The Halvorson Law Firm, Ste 130, 1757 E. Baseline Rd., Gilbert, AR, 85233, US

(21) Appl. No.: 11/180,462

(22) Filed: Jul. 12, 2005

(51) Int. Cl. B32B 1/08

(52) U.S. Cl. 428/34.7

(57) ABSTRACT

A fused silica capillary presenting a bore diameter in the range of approximately 1 μm to approximately 500 μm, a glass wall with a thickness ranging from approximately μm up to approximately 500 μm that is coated with approximately 10 μm to 50 μm of plastic cladding polymer is polymerized from solutions comprised of the of the following formulations: (a) monomer A, 10-80% by weight, or preferably 30-60% by weight: (b) monomer B, 0-80% by weight, or preferably 30-60% by weight; (c) methyl methacrylate, 0-90% by weight, or preferably 40-70% by weight (d) a free radical initiator, 1.0-3.0% by weight, preferably 1.5-2.0% by weight; (e) an adhesion promoter, 0-3.0% by weight, preferably 0.5-2.0% by weight; and (f) an antioxidant, 0-3.0% by weight, preferably 0.025-0.05% by weight.

### FIELD OF THE INVENTION

The present invention relates generally to applications of capillary conduit used in chemical analysis and specifically to fused silica capillary applied for bioseparations involving the use of ultraviolet light for detection.

### BACKGROUND OF THE INVENTION AND DESCRIPTION OF THE PRIOR ART

Polymer coated fused silica capillary has found wide use in analytical chemistry since the introduction of polyimide coated fused silica capillary for capillary gas chromatography (GC) by Hewlett-Packard some two decades ago. Soon thereafter, polyimide coated fused silica capillary was applied to an emerging new separation method: capillary electrophoresis (CE), the principal difference being that the capillary bores for CE were significantly smaller than the corresponding products designed for GC.

One problem presented itself in applying polyimide coated capillary to CE that remains incompletely resolved today. A very popular detection method used in CE is incompatible with the polyimide coating: fluorescence detection. Polyimide is quite opaque in the wavelength regions used to excite and detect fluorescence in the analyte molecules of interest, typically ultraviolet to near visible. The initial solution to this problem remains the method of art today. A short section of the capillary is stripped of the polyimide coating and positioned within the detector optics. This bare-glass section is known as the “detection window”.

While this approach works for analytical methods where all analytes of interest eventually pass through the bare capillary section, it does not work for applications where the entire separations volume is imaged, e.g. “Imaged Capillary Isoelectric Focusing”. The bare capillary section detection window is both difficult to form well and is extremely fragile. If less than 100% of the polyimide is removed in forming the window, background fluorescence from the residue can be crippling. Small flakes of partially oxidized polyimide (carbon or carbonized) at the window margins can break free and disrupt signal collection. The position of the detection window within the overall capillary length is also critical for reproducibility of methods and owing to the wide variety of “column effective lengths” (inlet to detection window dimension) required by this field of study on a dozens of capillary sized (bore and outer diameter), significant inventories of prepared columns must be prepared and maintained at considerable cost.

Polymicro Technologies, Inc. in 1990, dissolved pellets of the DuPont polymer in 3M Fluorinert FC-75, a fluorocarbon solvent, to form a viscous coating solution of in-line solvent casting of UV-transparent thin coatings on drawn silica capillary. The goal of producing this capillary was the elimination of the need to form detection windows of capillary for electrophoretic separations. At about the same time Beckman Instruments was developing a commerical CE instrument (P/ACE™) that utilized capillaries housed in cartridges that were cooled by an “electronic cooling liquid”, specifically one of the 3M Fluorinert™ family of products. DuPont now offers Teflon AF in prepared solutions, using the same 3M Fluorinert solvents, but UV transparent capillary remains obscure in CE applications as a result of Beckman's success in marketing the P/ACE™ instruments: the majority of CE instruments deployed today are incompatible with Teflon AF coated capillary because the capillary coating dissolves in the coolant used to maintain the capillary temperature constant.

Other problems with the Teflon AF coated capillary compound the poor acceptance of the material. Teflon AF does not adhere well to silica. Adhesion is optimized by heating the coated capillary to temperatures above the polymer glass transition temperature (160° C. for Teflon AF 1600 and 240° C. for Teflon AF 2400) but doing this potentially releases toxic decomposition products formed when the polymer is overheated. As a result, tensile strength for Teflon AF coated capillaries are exceedingly low at approximately 20 kpsi to 40 kpsi or about 5-fold lower than for polyimide coated capillary (as determined by “proof testing”, where the material is passed over rollers with diameters designed to impart a fixed stress level to 100% of the capillary under test in multiple axes). In addition, Teflon AF is extremely expensive at about $100 per gram and DuPont requires users to have a use license for each application.

In U.S. Pat. No. 6,188,813, Dourdeville discloses use of a short section of polytetraflyoroethylene tubing as a detection window for UV applications as another partial solution to the problems outlined above, but the basic problems for CE applications remain unaddressed in the art. The art disclosed herein addresses each of the problems that have limited the success of UV transparent capillary in analytical applications.

### SUMMARY OF THE INVENTION

The present invention utilizes relatively UV transparent fluoroacryalte and fluorourethane polymer coating materials, referred to herein as fluoropolymers, that are chosen for their ability to be applied on-line to drawn silica capillary, their high adhesion to silica and resistance to dissolution in fluorocarbon solvents.

A further characteristic of fluoropolymer coated silica capillary that finds some limited utility is the capacity to guide light within the silica annulus that is the capillary wall. Preferred fluoropolymers have refractive indices that are higher than that presented by the Teflon AF (η1.29 to ˜1.31) but sufficiently low to serve as cladding on fused silica, producing effective numerical apertures (NAs) of 0.20 to 0.50, such that annular waveguide capacity may be produced.

Fluoropolymers and similar polymers may be easily applied to the bore surface of the silica capillary, off line, post draw, if desired, so that the capillary annular core waveguide capability is preserved even when filled with higher refractive index materials.

It would be desirable to provide a UV transparent fluoropolymer capillary material with high tensile strength (>50 kpsi) with high resistance to abrasive damage and high resistance to dissolution in fluorocarbon solvents, at prices competitive with traditional polyimide coated capillary. It would also be desirable to provide silica capillary with the capacity to act as an annular core waveguide at numerical apertures ranging from approximately 0.20 to 0.50.

The invention disclosed herein is simple: fused silica capillary possessing a thin (˜10 μm to ˜50 μm) coating thickness of relatively UV transparent fluoropolymer coating on the outer diameter.

The fluoropolymer capillary coating solution (monomer plus additives) is extremely low viscosity in contrast to the Teflon AF of the prior art. The lower viscosity presents challenges in applying the coating to silica, but offers the benefit of improved penetration within microscopic flaws on the capillary surface. Routine “proof testing” of fluoropolymer coated capillaries at 100 kpsi yields no failures. The preferred fluoropolymer costs much less than Teflon AF, priced on a par with polyimides, such that UV transparent capillary may be offered for sale at prices competitive with polyimide coated capillary. When tightly coiled and immersed in Fluorinert FC-75, Teflon AF coated capillary fails in a matter of minutes where fluoropolymer coated capillaries do not fail, even within a order smaller coil (ten-fold the bending stress) in up to weeks of immersion.

It has been shown that slightly thicker than standard coating on silica filaments greatly increases resistance to damage in routine handling. For example, 240 μm diameter silica fiber (200 μm silica core, 240 μm fluorine doped silica cladding) coated with a 30 μm thickness of polyimide is virtually impervious to damage in routine handling as opposed to the same fiber coated with the standard 15 μm of polyimide, which is very sensitive to external damage.

Provision of capillary with thick Teflon AF coatings is prohibitively expensive both in terms of direct polymer costs and the costs of applying the coating. Teflon AF dissolved in Fluorinert FC-75 saturates at an approximately 18% solids solution (w/w). Fluorinert FC-75 is the single best solvent known for Teflon AF. When solvent cast on silica filaments at typical production speeds, the low solids content of the Teflon AF solution results in a maximum coating thickness of approximately 6 μm (4 μm to 5 μm is more typical) so that even the relatively thin wall coatings typical of commerical UV transparent capillary (typically 10 μm to 15 μm) require built-up of multiple layers to achieve. Commerical capillary drawing equipment is typically limited to a maximum of five solvent cast polymer coats, for a practical maximum coating thickness of 25 μm without incurring the expense of a second pass through the coating application portion of the draw line. Conversely, the present invention is 100% solids and may be applied in thicknesses up to 50 μm or more in one or two layers.

Among the objects of the present invention are the following:

To provide a new and useful silica capillary material for use in analytical chemistry and biotechnology that is completive in price with respect to traditional polyimide coated capillary;

To provide a new and useful silica capillary material that is transparent to wavelengths from within the ultraviolet through the visible and into the infrared;

To provide a new and useful silica capillary material that offers high tensile strength;

To provide a new and useful silica capillary material that offers high resistance to damage by particulate environmental contaminants and abrasion;

To provide a new and useful silica capillary material that offers a capacity to transmit light efficiently within the annular silica wall;

To provide a new and useful silica capillary material that resists dissolution and damage by fluorocarbon solvents.

The novel features that are considered characteristic of the invention are set forth with particularity in the appended claims. The invention itself, however, both as to its structure and its operation together with the additional objects and advantages thereof will best be understood from the following description of the preferred embodiment of the present invention. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments of the invention is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a perspective view of the preferred embodiment.

FIG. 2 is a perspective view of an alternative embodiment.

### DETAILED DESCRIPTION OF PREFERERED EMBODIMENTS

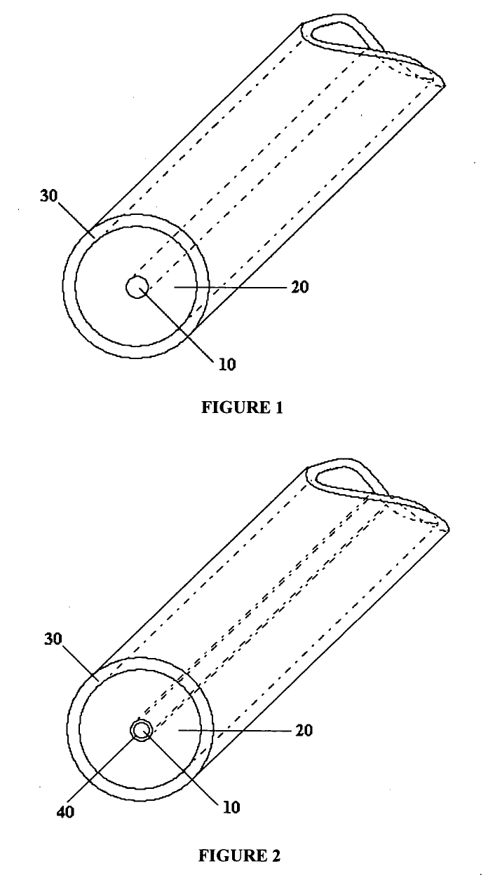

In general, the preferred embodiment, depicted in FIG. 1, is a fused silica capillary presenting a bore 10 diameter in the range of approximately 1 μm to approximately 500 μm, a glass wall 20 with a thickness ranging from approximately 25 μm up to approximately 500 μm that is coated with approximately 10 μm to 50 μm of plastic cladding polymer 30 that is polymerized from solutions comprised of the of the following formulations:
(a) monomer A, 10-80% by weight, or preferably 30-60% by weight:
(b) monomer B, 0-70% by weight, or preferably 30-60% by weight;
(c) methyl methacrylate, 0-90% by weight, or preferably 40-70% by weight
(d) a free radical initiator, 1.0-3.0% by weight, preferably 1.5-2.0% by weight;
(e) an adhesion promoter, 0-3.0% by weight, preferably 0.5-2.0% by weight; and
(f) an antioxidant, 0-3.0% by weight, preferably 0.025-0.05% by weight.
   Where one or more of the constituents identified above is a solid at room temperature a suitable solvent may be added to aid dispersion within the monomer solution. Monomer A and B are represented by the general structural formula: 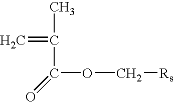
   where Rₛ is a perfluorocycloaliphatic or perfluorocycloalkoxy group having at least 5 carbon atoms and at least 9 fluorine atoms for monomer A and where Rₛ is a perfluoroaliphatic, perfluorocycloaliphatic or perfluorocycloalkoxy group having at least 5 carbon atoms and at least 9 fluorine atoms for monomer B.

An additional preferred embodiment is depicted in FIG. 2, where a thin film of the plastic cladding polymer 40 is deposited within the bore of the capillary depicted in FIG. 1.

Further embodiments of the invention may be produced with alternative formulations of the polymer cladding wherein the monomer or monomers used are essentially urethane analogs to the acrylates identified above.

The preferred embodiment of the invention is described above in the Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A coating composition for silica capillary comprising:
(a) about 10% to 80% by weight of polymerizable fluorine-containing methacrylic monomer (A) or a mixture of polymerizable fluorine-containing methacrylic monomer (A) and fluorine-containing methacrylic monomer (B), wherein monomer (A) can be represented by the formula CH₃CCH₂COOCH₂Rₛ wherein Rₛ is a perfluorocycloaliphatic or a perfluoroalkoxy group, having at least 5 carbon atoms and at least 9 fluorine atoms, and monomer (B), can be represented by the formula CH₃CCH₂COOCH₂Rₛ wherein Rₛ is a perfluoroaliphatic, perfluorocycloaliphatic or perfluorocycloalkoxy group, having at least 5 carbon atoms and at least 9 fluorine atoms; and
(b) about 00% to 90% by weight of methyl methacrylate.

2. The coating composition according to claim 1 further comprising a free radical initiator.

3. The coating composition according to claim 2 further comprising a vinyl-substituted adhesion promoter.

4. The coating composition according to claim 1, wherein the fluorine-containing monomer (A) is selected from the group consisting of 1,1-dihydroperfluorobutoxyisoproxyisopropyl methacrylate, 1,1-dihydroperfluorobutoxyisopropoxyisopropoxyisopropyl methacrylate, and perflurocyclohexylmethoxy-2-propoxy-1,1-dihydro-2-propyl methacrylate.

5. The coating composition according to claim 1, wherein the fluorine-containing monomer (B) is selected from the group consisting of 1,1-dihydroperfluorocyclohexylmethyl methacrylate, 1,1-dihydroperfluorooctyl methacrylate, 1,1-dihydroperfluorobutoxyisopropoxyisopropyl methacrylate, 1,1-dihydroperflurobutoxyisopropoxyisopropoxyisopropyl methacrylate, and perflurocyclohexylmethoxy-2-propoxy-1,1-dihydro-2-propyl methacrylate.

6. The coating composition according to claim 1, wherein the fluorine-containing monomer (A) is 1,1-dihydroperfluorobutoxyisopropoxyisopropyl methacrylate, and the fluorine-containing monomer (B) is 1,1-dihydroperfluorooctyl methacrylate.

7. The coating composition according to claim 1, wherein the fluorine-containing monomer (A) is 1,1-dihydroperfluorobutoxyisopropoxyisopropyl methacrylate, and the fluorine-containing monomer (B) is 1,1-dihydroperfluorocyclohexylmethyl methacrylate.

8. The coating composition according to claim 1, wherein the fluorine-containing monomer (A) is 1,1-dihydroperfluorobutoxyisopropoxyisopropyl methacrylate.

9. The coating composition according to claim 3, wherein the fluorine-containing monomer (A) is 1,1-dihydroperfluorobutoxyisopropoxyisopropyl methacrylate, and the vinyl-substituted adhesion promoter is methacrylic acid.

10. The coating composition according to claim 3, wherein the fluorine-containing monomer (A) is 1,1-dihydroperfluorobutoxyisopropoxyisopropyl methacrylate, and the vinyl-substituted adhesion promoter is acrylic acid.

11. The coating composition according to claim 3, wherein the refractive index is in the range of 1.37 to 1.47.

12. A silica capillary comprising a glass capillary coated with a polymer, said coating composition comprising:
(a) about 10% to 80% by weight of polymerizable fluorine-containing methacrylic monomer (A) or a mixture of polymerizable fluorine-containing methacrylic monomer (A) and fluorine-containing methacrylic monomer (B), wherein monomer (A) can be represented by the formula CH₃CCH₂COOCH₂Rₛ wherein Rₛ is a perfluorocycloaliphatic or a perfluoroalkoxy group, having at least 5 carbon atoms and at least 9 fluorine atoms, and monomer (B), can be represented by the formula CH₃CCH₂COOCH₂Rₛ wherein Rₛ is a perfluoroaliphatic, perfluorocycloaliphatic or perfluorocycloalkoxy group, having at least 5 carbon atoms and at least 9 fluorine atoms; and
(b) about 0% to 90% by weight of methyl methacrylate.

13. The capillary according to claim 12 further comprising a free radical initiator.

14. The capillary according to claim 13 further comprising a vinyl-substituted adhesion promoter.

15. The capillary according to claim 12, wherein the fluorine-containing monomer (A) is selected from the group consisting of 1,1-dihydroperfluorobutoxyisopropoxyisopropyl methacrylate, 1,1-dihydroperfluorobutoxyisopropoxyisopropoxyisopropyl methacrylate, and perflurocyclohexylmethoxy-2-propoxy-1,1-dihydro-2-propyl methacrylate.

16. The capillary according to claim 12, wherein the fluorine-containing monomer (B) is selected from the group consisting of 1,1-dihydroperfluorocyclohexylmethyl methacrylate, 1,1-dihydroperfluorooctyl methacrylate, 1,1-dihydroperfluorobutoxyisopropoxyisopropyl methacrylate, 1,1 -dihydroperflurobutoxyisopropoxyisopropoxyisopropyl methacrylate, and perflurocyclohexylmethoxy-2-propoxy-1,1-dihydro-2-propyl methacrylate.

17. The capillary according to claim 12, wherein the fluorine-containing monomer (A) is 1,1-dihydroperfluorobutoxyisopropoxyisopropyl methacrylate, and the fluorine-containing monomer (B) is 1,1-dihydroperfluorooctyl methacrylate.

18. The capillary according to claim 12, wherein the fluorine-containing monomer (A) is 1,1-dihydroperfluorobutoxyisopropoxyisopropyl methacrylate, and the fluorine-containing monomer (B) is 1,1-dihydroperfluorocyclohexylmethyl methacrylate.

19. The capillary according to claim 12, wherein the fluorine-containing monomer (A) is 1,1-dihydroperfluorobutoxyisopropoxyisopropyl methacrylate.

20. The capillary according to claim 15, wherein the fluorine-containing monomer (A) is 1,1-dihydroperfluorobutoxyisopropoxyisopropyl methacrylate, and the vinyl-substituted adhesion promoter is methacrylic acid.

21. The capillary according to claim 15, wherein the fluorine-containing monomer (A) is 1,1-dihydroperfluorobutoxyisopropoxyisopropyl methacrylate, and the vinyl-substituted adhesion promoter is acrylic acid.

22. The capillary according to claim 12, wherein the capillary substrate is selected from the group consisting of fused natural quartz, synthetic fused silica, and other glasses.

23. The capillary according to claim 22, wherein the refractive index of the coating composition is in the range of 1.37 to 1.47.

24. A capillary comprising a glass hollow cylinder coated on an outer diameter with a polymer, said polymer consisting of a fluoropolymer that is appreciably transparent in the ultraviolet and visible regions of the light spectrum from approximately 300 nm to approximately 600 nm and is resistant to dissolution or damage by fluorocarbon solvents.

25. The capillary according to claim 24 further comprising polymer coating on an inner diameter, said polymer consisting of a fluoropolymer that is appreciably transparent in the ultraviolet and visible regions of the light spectrum from approximately 300 nm to approximately 600 nm and is resistant to dissolution or damage by fluorocarbon solvents.
